(19) United States
(12) Patent Application Publication
(10) Pub. No.: US 2024/0236934 A1
(43) Pub. Date: Jul. 11, 2024

(54) POSITIONING PRECISION ESTIMATION METHOD AND APPARATUS, ELECTRONIC DEVICE, AND STORAGE MEDIUM

(71) Applicant: Tencent Technology (Shenzhen) Company Limited, Shenzhen (CN)

(72) Inventors: Xin ZHANG, Shenzhen (CN); Zhanduo YANG, Shenzhen (CN); Yanxing ZHOU, Shenzhen (CN); Xin LI, Shenzhen (CN); Weizhi ZHENG, Shenzhen (CN); Chang LIU, Shenzhen (CN)

(73) Assignee: Tencent Technology (Shenzhen) Company Limited, Shenzhen (CN)

(21) Appl. No.: 18/612,972

(22) Filed: Mar. 21, 2024

Related U.S. Application Data
(63) Continuation of application No. PCT/CN2023/091078, filed on Apr. 27, 2023.

(30) Foreign Application Priority Data
Jul. 15, 2022 (CN) 202210837512.8

(51) Int. Cl. H04W 64/00; G01S 19/25; G01S 19/45

(52) U.S. Cl. CPC H04W 64/006; G01S 19/252; G01S 19/45

(57) ABSTRACT

A method includes obtaining first traveling information of a vehicle from a sensor associated with the vehicle, and determining, based on the first traveling information, first location information of the vehicle and a first intermediate variable that is used in the determining the first location information. The method also includes determining a target precision estimation model from a plurality of pre-trained precision estimation models based on the first traveling information and the first intermediate variable. The plurality of pre-trained precision estimation models are obtained by training a machine learning model based on a training sample set. The method also includes inputting the first location information and the first intermediate variable into the target precision estimation model to obtain second location information of the vehicle and a precision error of the first location information relative to the second location information.

### RELATED APPLICATIONS

The present application is a continuation of International Application No. PCT/CN2023/091078, entitled “POSITIONING PRECISION ESTIMATION METHOD AND APPARATUS, ELECTRONIC DEVICE, AND STORAGE MEDIUM” and filed on Apr. 27, 2023, which claims priority to Chinese Patent Application No. 202210837512.8, entitled “POSITIONING PRECISION ESTIMATION METHOD AND APPARATUS, ELECTRONIC DEVICE, AND STORAGE MEDIUM” and filed on Jul. 15, 2022. The entire disclosures of the prior applications are hereby incorporated by reference in their entirety.

### FIELD OF THE TECHNOLOGY

This disclosure relates to the intelligent transportation field, including positioning precision estimation.

### BACKGROUND OF THE DISCLOSURE

Intelligence is one of main lines of current development of vehicles. Progress of vehicle intelligence relies on maturity of vehicle sensors, algorithm software, and decision-making platforms. A combination of high-precision positioning and a high-definition map can provide accurate absolute location information for a vehicle. The absolute location information and relative location information of a sensor complement each other, to improve safety of intelligent driving. With continuous improvement of vehicle intelligence, importance of high-precision positioning becomes increasingly prominent.

Precision error assessment is a quite important part of high-precision positioning. A precision error of positioning is a possible error included in this positioning, and can be quite helpful for subsequent vehicle control, collision avoidance, intelligent vehicle speeds, path planning, and behavioral decision-making. However, currently, no solution is capable of effectively assessing a precision error of high-precision positioning.

### SUMMARY

Embodiments of this disclosure provide a positioning precision estimation method and apparatus, a device, and a storage medium, to effectively assess a precision error of high-precision positioning.

Some aspects of the disclosure provide a method for positioning precision estimation. The method includes obtaining first traveling information of a vehicle from a sensor associated with the vehicle, and determining, based on the first traveling information, first location information of the vehicle and a first intermediate variable that is used in the determining the first location information. The method also includes determining a target precision estimation model from a plurality of pre-trained precision estimation models based on the first traveling information and the first intermediate variable. The plurality of pre-trained precision estimation models are obtained by training a machine learning model based on a training sample set, and a training sample in the training sample set includes sample location information of a sample vehicle and a sample intermediate variable that is used in determining the sample location information of the sample vehicle. The method also includes inputting the first location information and the first intermediate variable into the target precision estimation model to obtain second location information of the vehicle and a precision error of the first location information relative to the second location information. Apparatus and non-transitory computer-readable storage medium counterpart embodiments are also contemplated.

Some aspects of the disclosure provide a method for training a precision estimation model. The method includes obtaining sample traveling information of a sample vehicle in a first time from a sensor, determining, based on the sample traveling information, first sample location information of the sample vehicle and a sample intermediate variable that is used in the determining the first sample location information, obtaining second sample location information of the sample vehicle in the first time from a positioning device and determining a training sample set. A training sample in the training sample set includes the first sample location information, the second sample location information, and the sample intermediate variable. The method also includes training the precision estimation model based on the training sample set. Apparatus and non-transitory computer-readable storage medium counterpart embodiments are also contemplated.

Based on the foregoing technical solutions, in embodiments of this disclosure, the first location information of the vehicle and the first intermediate variable used in the process of determining the first location information can be obtained based on the first traveling information, and then the target precision estimation model is determined from the pre-trained precision estimation model based on the first traveling information and the first intermediate variable, and the first location information and the first intermediate variable are input to the target precision estimation model to obtain the second location information of the vehicle and the precision error of the first location information relative to the second location information. In this way, a precision error of high-precision positioning can be effectively assessed.

### BRIEF DESCRIPTION OF THE DRAWINGS

FIG. 1 is a schematic diagram of a system architecture according to an embodiment of this disclosure.

FIG. 2 is a schematic flowchart of a model training method according to an embodiment of this disclosure.

FIG. 3 is a schematic diagram of a network architecture to which embodiments of this disclosure are applicable.

FIG. 4 is a schematic flowchart of a method for obtaining training sample data according to an embodiment of this disclosure.

FIG. 5 is a schematic flowchart of a positioning precision estimation method according to an embodiment of this disclosure.

FIG. 6 is a specific example of a positioning precision estimation method according to an embodiment of this disclosure.

FIG. 7 is a schematic block diagram of a positioning precision estimation apparatus according to an embodiment of this disclosure.

FIG. 8 is a schematic block diagram of a model training apparatus according to an embodiment of this disclosure.

FIG. 9 is a schematic block diagram of an electronic device according to an embodiment of this disclosure.

### DESCRIPTION OF EMBODIMENTS

The technical solutions in embodiments of this disclosure are described in the following with reference to the accompanying drawings in embodiments of this disclosure. The described embodiments are merely some rather than all of embodiments of this disclosure.

It is to be understood that “B corresponding A” in embodiments of this disclosure indicates that B is associated with A. In an implementation, B may be determined based on A. However, it is further to be understood that determining B based on A does not mean that B is determined only based on A, but B may be alternatively determined based on A and/or other information.

In descriptions of this disclosure, “at least one” means one or more, and “a plurality of” means two or more, unless otherwise specified. In addition, “and/or” describes an association relationship between associated objects and indicates that three relationships may exist. For example, A and/or B may indicate the following three cases: Only A exists, both A and B exist, and only B exists, where A and B may be singular or plural. The character “/” usually indicates an “or” relationship between the associated objects. “At least one of the following items” or a similar expression indicates any combination of the items, including one of the items or any combination of a plurality of the items. For example, at least one of a, b, or c may indicate a, b, c, a and b, a and c, b and c, or a, b, and c, where a, b, and c may be singular or plural.

It is further to be understood that descriptions such as “first” and “second” in embodiments of this disclosure are merely intended to describe and distinguish between objects, but do not indicate an order or constitute a particular limitation on the number of devices in embodiments of this disclosure, and shall not be construed as a limitation on embodiments of this disclosure.

It is further to be understood that particular features, structures, or characteristics related to an embodiment in this specification are included in at least one embodiment of this disclosure. In addition, these particular features, structures, or characteristics may be combined in one or more embodiments in any appropriate manner.

In addition, the terms “comprise”, “include”, and any variants thereof are intended to cover a non-exclusive inclusion. For example, a process, method, system, product, or server that includes a list of steps or units is not necessarily limited to those steps or units that are expressly listed, but may include other steps or units that are not expressly listed or are inherent to the process, method, system, product, or device.

Embodiments of this disclosure may be applied to the field of artificial intelligence (AI) technologies.

For example, AI involves a theory, a method, a technology, and an application system that use a digital computer or a machine controlled by a digital computer to simulate, extend, and expand human intelligence, perceive an environment, obtain knowledge, and use the knowledge to obtain an optimal result. In other words, AI is a comprehensive technology in computer science and attempts to understand the essence of intelligence and produce a new intelligent machine that can react in a manner similar to human intelligence. AI is to study design principles and implementation methods of various intelligent machines, to enable the machines to have functions of perception, reasoning, and decision-making.

The AI technology is, for example, a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

With research and development of AI technologies, AI technologies have been studied and applied in many fields, for example, common fields such as smart household, smart wearable devices, virtual assistants, smart speakers, smart marketing, self-driving, autonomous driving, drones, robots, smart healthcare, and intelligent customer service. It is believed that AI technologies are to be applied in more fields and play an increasingly important part with development of technologies.

Embodiments of this disclosure may relate to an autonomous driving technology in AI technologies. Depending on collaboration of AI, computer vision, a radar, a monitoring apparatus, and a global positioning system, the autonomous driving technology enables a computer to autonomously and safely operate a motor vehicle without any active operation performed by a person. The autonomous driving technology usually includes a high-definition map, environmental perception, behavioral decision-making, path planning, motion control, and other technologies. The autonomous driving technology has an extensive application prospect. Specifically, technical solutions provided in embodiments of this disclosure include a technology for assessing a positioning precision error, which may be specifically used for assessing positioning precision of autonomous driving.

Embodiments of this disclosure may also relate to machine learning (ML) in AI technologies. ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

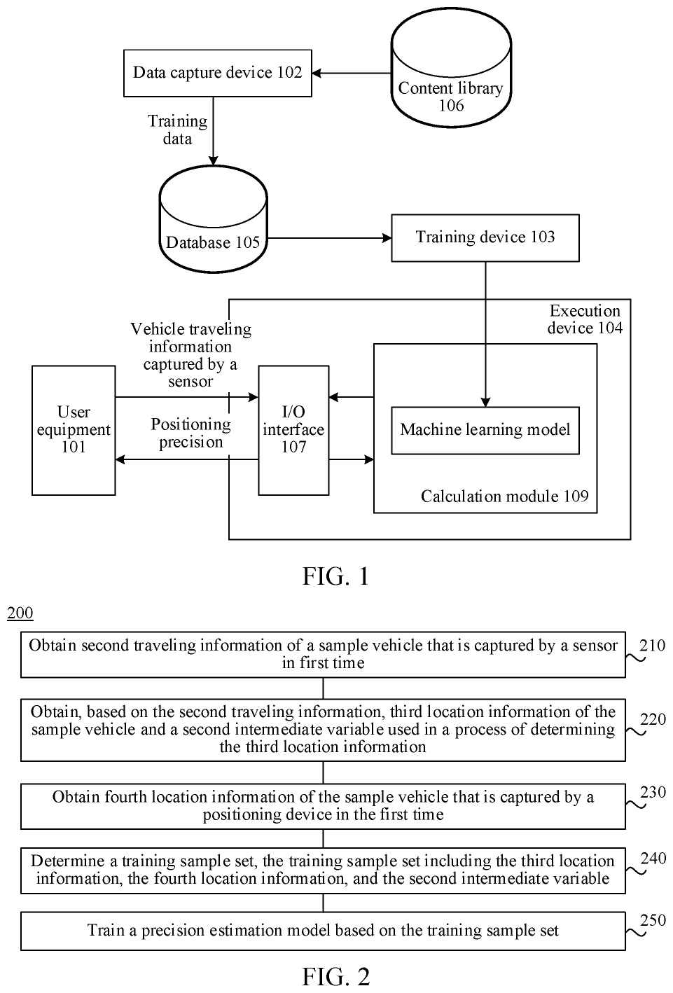

FIG. 1 is a schematic diagram of a system architecture according to an embodiment of this disclosure. As shown in FIG. 1, the system architecture may include user equipment 101, a data capture device 102, a training device 103, an execution device 104, a database 105, and a content library 106.

The data capture device 102 is configured to read training data from the content library 106, and store the read training data to the database 105. Training data included in embodiments of this disclosure includes location information #1 and location information #2 of a sample vehicle and an intermediate variable used in a process of determining the location information #1. The location information #1 is determined based on traveling information of the sample vehicle that is captured by a sensor. The location information #2 is location information of the sample vehicle that is captured by a positioning device.

The training device 103 trains a machine learning model based on training data maintained in the database 105, so that a trained machine learning model can effectively assess positioning precision. The machine learning model obtained by the training device 103 may be applied to different systems or devices.

In addition, as shown in FIG. 1, the execution device 104 is equipped with an I/O interface 107 for exchanging data with an external device, for example, receiving, through the I/O interface, vehicle traveling information that is captured by a sensor and that is transmitted by the user equipment 101. A calculation module 109 in the execution device 104 obtains positioning precision for the vehicle based on the traveling information and the trained machine learning model. The machine learning model may transmit a corresponding result to the user equipment 101 through the I/O interface.

The user equipment 101 may include a smart vehicle, an in-vehicle terminal, a mobile phone, a tablet computer, a notebook computer, a palmtop computer, a mobile Internet device (MID), or another terminal device.

The execution device 104 may be a server.

For example, the server may be a computing device such as a rack server, a blade server, a tower server, or a cabinet server. The server may be an independent test server or a test server cluster including a plurality of test servers.

There may be one or more servers. In the case of a plurality of servers, at least two servers are configured to provide different services, and/or at least two servers are configured to provide a same service, for example, provide the same service in a load balancing manner. This is not limited in embodiments of this disclosure.

The server may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. Alternatively, the server may become a node of a blockchain.

In this embodiment, the execution device 104 is connected to the user equipment 101 through a network. The network may be a wireless or wired network, for example, an intranet, the Internet, a Global System for Mobile Communications (GSM) network, a wideband code division multiple access (WCDMA) network, a 4G network, a 5G network, a Bluetooth network, a Wi-Fi network, or a call network.

FIG. 1 is only a schematic diagram of a system architecture according to an embodiment of this disclosure, and a location relationship between the devices, the components, the modules, and the like shown in the figure does not constitute any limitation. In some embodiments, the data capture device 102, the user equipment 101, the training device 103, and the execution device 104 may be the same device. The database 105 may be distributed on one or more servers, and the content library 106 may be distributed on one or more servers.

Related terms in embodiments of this disclosure are described below.

High-precision positioning: High-precision positioning generally refers to positioning with decimeter-level, centimeter-level, or even higher-level precision, is capable of providing a high-precision positioning result for a vehicle, and is one of indispensable core technologies for safe driving in autonomous driving, remote driving, and the like. The high-precision positioning plays an important role in aspects of horizontal/vertical accurate positioning for a vehicle, obstacle detection and collision avoidance, smart vehicle speed control, path planning, behavioral decision-making, and the like.

In the high-precision positioning, an absolute location of a vehicle can be accurately determined based on a high-precision absolute reference system. For example, the high-precision absolute reference system is a high-definition map. A map layer of the high-definition map includes a large number of road attribute elements with centimeter-level precision, including but not limited to road edges, lane edges, center lines, and other information. During traveling of the vehicle, accurate navigation may be performed based on information in the high-definition map.

Multi-source fusion positioning: a technology that integrates a plurality of positioning technologies based on an information fusion policy and is capable of integrating related positioning means including satellite positioning, wireless communication signal positioning, sensor positioning, and the like to obtain a better fusion positioning result than a single positioning solution. High-precision positioning can be implemented through multi-source fusion positioning.

The satellite positioning is a technology for positioning by using a satellite (for example, GNSS). The wireless communication signal positioning is a technology for positioning by using a wireless communication signal (for example, a Wi-Fi signal or an ultra wideband (UWB) signal). The sensor positioning is a technology for positioning by using information captured by a sensor (for example, a visual sensor, a vehicle speed sensor, or an inertial measurement unit (IMU) sensor).

Visual positioning: a technology for positioning by using information captured by a visual sensor. In the visual positioning, road attribute elements at a positioning layer of a high-definition map may be recognized and sensed by the visual sensor, and vehicle location information is calculated based on a visual algorithm. In the visual positioning, sensors such as the high-definition map and a camera may be fully reused without additional deployment of hardware. This has significant advantages in costs.

Inertial positioning: a technology for positioning by using information captured by an IMU sensor. In the inertial positioning, angular rate and acceleration information of a vehicle is measured by the IMU sensor, and instantaneous speed and location information of a carrier is automatically calculated by using the Newton's law of motion. The inertial positioning has characteristics of not relying on external information, not radiating energy to the outside world, not being interfered with, and good concealment.

Global navigation satellite system (GNSS): a general navigation satellite system, including a global navigation satellite system, a regional navigation satellite system, and an enhanced navigation satellite system, for example, the Global Positioning System (GPS), GLONASS, Galileo of the Europe, the BeiDou navigation satellite system, and related enhanced systems such as the Wide Area Augmentation System (WAAS), the European Geostationary Navigation Overlay Service (EGNOS), and the Multi-functional Satellite Augmentation System (MSAS), and further including other navigation satellite systems that are being built or to be built in the future. The GNSS is a multi-system, multi-layer, and multi-mode complex combined system.

Usually, in ordinary satellite positioning, a plurality of satellite signals are received for determining a location. However, the satellite signals fluctuate when passing through an ionospheric layer or a tropospheric layer, causing an error. In this case, meter-level positioning precision is achieved. A ground enhanced base station may calculate a satellite positioning error by using a real-time kinematic (RTK) carrier-phase differential technology to further correct a location and improve positioning precision. For example, precision of satellite positioning may be enhanced from meters to centimeters.

In addition, in a case that an obstacle exists on the ground, a signal is likely to be weak or lost in satellite positioning. In this case, a vehicle may use inertial positioning, visual positioning, or another positioning function to ensure that a navigation system continues to operate.

RTK carrier-phase differential technology: a differential method for processing carrier phase observation values of two measuring stations in real time. A carrier phase captured by a reference station is transmitted to a user receiver for calculating a difference and resolving coordinates. In the RTK carrier-phase differential technology, centimeter-level positioning precision can be achieved outdoors in real time by using an RTK carrier-phase differential method. This provides a new measurement principle and method for engineering setting-out, topographic mapping, and various control surveys, and improves operation efficiency.

Precision error assessment is a quite important part of high-precision positioning. A precision error of positioning is a possible error included in this positioning, and can be quite helpful for subsequent vehicle control, collision avoidance, intelligent vehicle speeds, path planning, and behavioral decision-making. However, currently, no solution is capable of effectively assessing a precision error of high-precision positioning.

In view of this, embodiments of this disclosure provide a positioning precision estimation method and apparatus, a device, and a storage medium, to effectively assess a precision error of high-precision positioning.

Specifically, in embodiments of this disclosure, first traveling information of a vehicle that is captured by a sensor may be obtained, first location information of the vehicle and a first intermediate variable used in a process of determining the first location information are obtained based on the first traveling information, and then a target precision estimation model is determined from a pre-trained precision estimation model based on the first traveling information and the first intermediate variable, and the first location information and the first intermediate variable are input to the target precision estimation model to obtain second location information of the vehicle and a precision error of the first location information relative to the second location information.

The precision estimation model is obtained by training a machine learning model based on a training sample set. A training sample in the training sample set includes location information of a sample vehicle and an intermediate variable used in a process of determining the location information. For example, the training sample set may include third location information and fourth location information of the sample vehicle and a second intermediate variable used in a process of determining the third location information. The third location information is determined based on second traveling information of the sample vehicle that is captured by a sensor in first time. The fourth location information includes location information of the sample vehicle that is captured by a positioning device in the first time.

Therefore, in embodiments of this disclosure, the first location information of the vehicle and the first intermediate variable used in the process of determining the first location information can be obtained based on the first traveling information, and then the target precision estimation model is determined from the pre-trained precision estimation model based on the first traveling information and the first intermediate variable, and the first location information and the first intermediate variable are input to the target precision estimation model to obtain the second location information of the vehicle and the precision error of the first location information relative to the second location information. In this way, a precision error of high-precision positioning can be effectively assessed.

In embodiments of this disclosure, based on positioning location information of the vehicle that is determined based on the traveling information of the vehicle captured by the sensor and an intermediate variable used in a process of determining the positioning location information, the precision estimation model can predict real location information of the vehicle that is captured by the positioning device, and estimate a precision error of the positioning location information relative to the real location information.

The positioning precision estimation method in embodiments of this disclosure may be divided into two stages: an offline modeling stage and an online estimation stage. In the offline modeling stage, a precision estimation model may be obtained through training based on captured data of a sample vehicle. In the online estimation stage, traveling information of a vehicle may be captured in real time, and positioning precision for the vehicle is estimated based on the traveling information and the precision estimation model built in the offline modeling stage.

The stages are described in detail below with reference to the accompanying drawings.

First, the offline modeling stage is described.

FIG. 2 is a schematic flowchart of a model training method 200 according to an embodiment of this disclosure. The method 200 may be performed by any electronic device with a data processing capability. For example, the electronic device may be implemented as a server or a terminal device. For another example, the electronic device may be implemented as the training device 103 shown in FIG. 1. This is not limited in this disclosure.

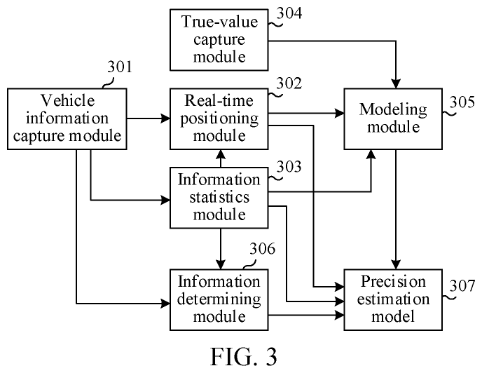

FIG. 3 is a schematic diagram of a network architecture to which embodiments of this disclosure are applicable. The network architecture includes a vehicle information capture module 301, a real-time positioning module 302, an information statistics module 303, a truc-value capture module 304, a modeling module 305, an information determining module 306, and a precision estimation model 307. The vehicle information capture module 301, the real-time positioning module 302, the information statistics module 303, the true-value capture module 304, and the modeling module 305 may be used for model training in the offline modeling stage. The model training method 200 is described below with reference to FIG. 3.

As shown in FIG. 2, the method 200 includes steps 210 to 250.

210: Obtain second traveling information of a sample vehicle that is captured by a sensor in first time.

For example, the vehicle information capture module 301 in FIG. 3 may obtain the second traveling information of the sample vehicle that is captured by the sensor in the first time. The first time may be a current or previous period of time. This is not limited. After obtaining the second traveling information, the vehicle information capture module 301 may transmit the second traveling information to the real-time positioning module 302. In some embodiments, the second traveling information may be further transmitted to the information statistics module 303.

In some embodiments, the second traveling information includes traveling information of the sample vehicle that is captured by at least one of an inertial measurement unit (IMU) sensor, a vehicle speed sensor, and a visual sensor.

For example, the sensor may be any sensor disposed on the sample vehicle for capturing vehicle traveling information, for example, a GNSS sensor, the IMU sensor, the vehicle speed sensor, the visual sensor, or another sensor device.

For example, traveling information of the sample vehicle that is captured by the GNSS sensor may include the following information about the sample vehicle in current positioning: a longitude, a latitude, a DOP value, a precision value, whether the current positioning is effective, and whether the current positioning is fixed.

The GNSS sensor is capable of properly receiving a GNSS signal in the case of no occlusion or weak occlusion (for example, on a road for normal traveling). Therefore, the current positioning is effective. This may also be referred to as that the GNSS sensor is effective. The GNSS sensor is unable to properly receive a GNSS signal in the case of serious occlusion (for example, in a road section with a tunnel, an elevated highway, or a mountain). Therefore, the current positioning is ineffective. This may also be referred to as that the GNSS sensor is ineffective or fails.

A solution obtained by the GNSS sensor by using an RTK carrier-phase differential technology may be referred to as a fixed solution. In a case of that a GNSS signal for the GNSS sensor is blocked (for example, on a mountain road), another type of solution, for example, a floating-point solution, may be obtained when the RTK carrier-phase differential technology cannot be used. Whether the current positioning is fixed may indicate whether a fixed solution is obtained in the current positioning by using the RTK carrier-phase differential technology. Precision of the fixed solution is the highest, and can reach a centimeter level.

For example, traveling information of the sample vehicle that is captured by the IMU sensor may include acceleration values in x-axis, y-axis, and z-axis directions of an accelerometer and angular velocities in x-axis, y-axis, and z-axis directions of a gyroscope.

For example, traveling information of the sample vehicle that is captured by the vehicle speed sensor may include a direction and a magnitude of a vehicle speed of the sample vehicle.

For example, traveling information of the sample vehicle that is captured by the visual sensor may include an equation for a lane line in which the sample vehicle is located, a type (for example, a real line, dashed line, a white line, or a yellow line) of the lane line, and coordinates of an obstacle.

220: Obtain, based on the second traveling information, third location information of the sample vehicle and a second intermediate variable used in a process of determining the third location information.

For example, the real-time positioning module 302 in FIG. 3 may obtain, based on the second traveling information, the third location information of the sample vehicle and the second intermediate variable used in the process of determining the third location information. After obtaining the third location information and the second intermediate variable, the real-time positioning module 302 may transmit the third location information and the second intermediate variable to the modeling module 305.

In some embodiments, the real-time positioning module 302 may obtain the second traveling information of the sample vehicle that is captured by the sensors from the vehicle information capture module 301, and may obtain the third location information of the sample vehicle in conjunction with other information. For example, the other information may include map information, for example, a high-definition map.

In some embodiments, the third location information may include a longitude, a latitude, and a vehicle heading of the sample vehicle.

The vehicle heading may be an angle at which the front of the vehicle deviates from a preset direction. For example, an angle at which the front of the vehicle deviates from a true north direction clockwise may be used as the vehicle heading.

In a process of determining the third location information of the sample vehicle based on the second traveling information, some intermediate variables, namely, the second intermediate variable, may be further obtained.

In some embodiments, the third location information and the second intermediate variable may be obtained based on the second traveling information and the map information. The second intermediate variable may include information about an error between lane information determined based on the second traveling information and lane information of the sample vehicle in the map information.

For example, the second intermediate variable may include the following two categories:
(1) an intermediate variable obtained based on the high-definition map and information captured by the visual sensor, for example, a difference between a lane width provided by the sensor and a lane width in the map, a distance of lane line optimization, an initial optimization error, and a final optimization error; and
(2) an intermediate variable obtained based on the high-definition map and information captured by the GNSS sensor and the visual sensor, for example, a probability that a positioning point is in each lane, a lane with a highest probability of being a positioning point, and whether lane information provided by the GNSS sensor is consistent with lane information provided by the visual sensor.

In some embodiments, the second intermediate variable may further include at least one of a covariance of an optimization algorithm used for determining the third location information and a statistical value of the second traveling information in a second time period.

For example, the second intermediate variable may further include the following two categories:
(3) a covariance of an optimization algorithm, for example, a speed covariance, a covariance of an IMU sensor deviation, and a covariance of an estimated attitude (for example, an estimated longitude, latitude, and vehicle heading of the vehicle); and
(4) a statistical value of a parameter captured by a statistics sensor within a period of time, for example, a statistical value of information captured by the GNSS sensor within 20 s, a mean and a variance of a vehicle speed within 1 s, a mean and a variance of acceleration values in the x-axis, y-axis, and z-axis directions of the accelerometer and a mean and a variance of angular velocity values in the x-axis, y-axis, and z-axis directions of the gyroscope within 10 s, and a distance between a location of the last positioning point that is obtained by the GNSS sensor and a positioning result.

In (1), the distance of lane line optimization may be a distance at which a lane line obtained through visual positioning is optimized when the lane line, obtained through visual positioning, of a lane in which the vehicle is located is aligned with a lane line, in the high-definition map, of the lane in which the vehicle is located. The initial optimization error may be an error between the lane line, obtained through visual positioning, of the lane in which the vehicle is located and the lane line, in the high-definition map, of the lane in which the vehicle is located before the alignment. The final optimization error may be an error between the lane line, obtained through visual positioning, of the lane in which the vehicle is located and the lane line, in the high-definition map, of the lane in which the vehicle is located after the alignment.

In (2), the GNSS sensor may perform high-precision positioning by using the RTK carrier-phase differential technology to obtain a probability that a positioning point for the vehicle is in each lane, and a lane with a highest probability of being a positioning point may be determined as a lane in which the vehicle is located. Based on an optimization result in (1), the visual sensor can also further obtain a probability that a positioning point for the vehicle is in each lane, and a lane with a highest probability of being a positioning point is determined as a lane in which the vehicle is located.

In (3), different optimization algorithms and different optimization objectives may be used. This is not limited in this disclosure. For example, the optimization algorithm may be an optimization algorithm based on an overall optimization form, for example, optimization is performed by using information captured by all sensors within a period of time; or the optimization algorithm may be an optimization algorithm based on a filter form, for example, optimization is performed by using information captured by a sensor at an earlier time point and a later time point.

In (4), the statistical value of the information captured by the GNSS sensor within 20 s includes but is not limited to an effective ratio, a fixed ratio, a mean and a variance of precision values, a mean and a variance of DOP values, precision and a DOP value of the last GNSS positioning point, whether positioning is fixed, and whether positioning is effective.

The effective ratio may be a ratio of effective positioning by the GNSS sensor to all positioning by the GNSS sensor. The fixed ratio may be a ratio of fixed solutions in positioning results obtained by the GNSS sensor to all positioning results.

For example, the information statistics module 303 in FIG. 3 may collect statistics on statistical values of parameters that are provided by the vehicle information capture module 301 within a period of time to obtain the statistical value in (4). This is not limited in this disclosure. After obtaining the statistical value, the information statistics module 303 may transmit the statistical value to the real-time positioning module 302, or transmit the statistical value to the modeling module 305.

230: Obtain fourth location information of the sample vehicle that is captured by a positioning device in the first time.

For example, the positioning device may be the true-value capture module 304 in FIG. 3, and may be disposed on the sample vehicle. Correspondingly, the fourth location information may also be referred to as true-value location information. To be specific, the fourth location information may be considered as a real location of the sample vehicle. This is not limited in this disclosure.

The positioning device may have high positioning precision, for example, may be SPAN-ISA-100C, SPAN-CPT, or another device. Usually, higher precision of the used positioning device indicates better effect of positioning precision estimation.

In some embodiments, the fourth location information may include a longitude, a latitude, and a vehicle heading of the sample vehicle.

240: Determine a training sample set, the training sample set including the third location information, the fourth location information, and the second intermediate variable.

For example, the modeling unit 305 in FIG. 3 may determine the training sample set. The training sample set may include a large number of training samples, and cach training sample may include the third location information and the second intermediate variable that are obtained in step 220 and the fourth location information in step 230.

Different vehicles have different operational design domains (ODDs). For example, an autonomous vehicle may have a control system designed for driving in an urban environment and another control system designed for driving on a highway. Therefore, a large amount of data needs to be captured in different scenarios. For example, at least highways, urban expressways, urban ordinary roads, and highway or urban tunnel sections need to be covered.

In embodiments of this disclosure, a large amount of data generated during traveling of the sample vehicle may be captured in different scenarios to generate the training sample set. For example, in a sufficiently large number of road sections such as highways, urban expressways, and urban ordinary roads, traveling information of the sample vehicle during traveling may be captured by the sensor, and location information of the sample vehicle during traveling may be captured by the positioning device. In an example, data for a distance of at least 5000 kilometers or more than 10,000 kilometers may be captured in each scenario.

In an example implementation, during determining of the training sample set, a positioning result (for example, the third location information) obtained by the real-time positioning module 302 and a positioning result (for example, the fourth location information) obtained by the true-value capture module 304 may be aligned according to time, and all intermediate variables of the real-time positioning module 302 are extracted. In an example, one training sample may be generated at one time point. To be specific, each training sample may include a positioning result obtained by the real-time positioning module 302, a positioning result obtained by the true-value capture module 304, and an intermediate variable of the real-time positioning module 302 at a corresponding time point.

In some embodiments, for tunnel sections, tunnel section simulation may be performed based on data of the sample vehicle that is captured in a normal road section (to be specific, a road section without a tunnel) to obtain a training sample data corresponding to the tunnel sections.

Specifically, in a tunnel section, data captured by the GNSS sensor cannot be obtained because a GNSS signal is blocked. A cumulative error caused by derivation only based on another sensor such as the IMU sensor cannot meet a precision requirement, and precision of location information captured by the positioning device in the tunnel section decreases.

Usually, an autonomous driving or remote driving technology only requires that high positioning precision be kept within a period of time or a distance after a vehicle enters a tunnel section. Therefore, a part of a file captured by the GNSS sensor may be manually set to be ineffective to simulate a tunnel section. Correspondingly, a road section corresponding to the ineffective part in the file captured by the GNSS sensor may be considered as a tunnel section. In this way, a training sample data corresponding to the tunnel section is obtained. In addition, the fourth location information of the sample vehicle, in the training sample, that is captured by the positioning device has sufficiently high precision compared with location information captured by a positioning device in a real tunnel.

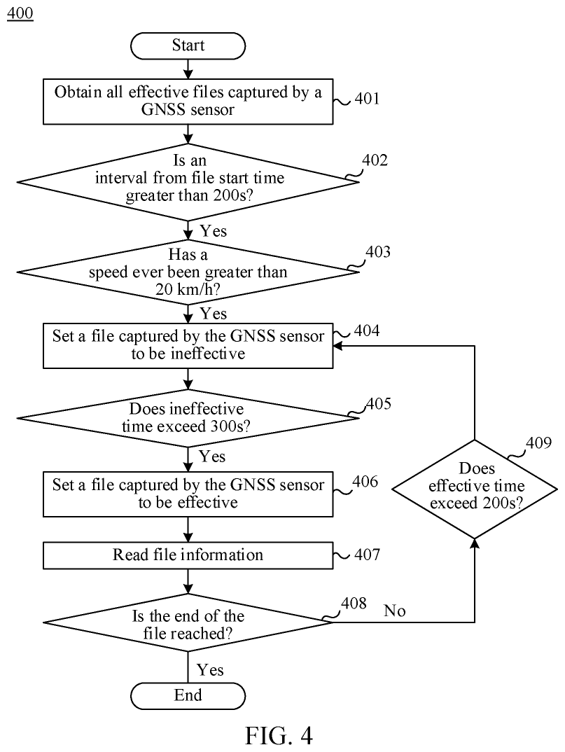

FIG. 4 is a schematic flowchart of a method 400 for obtaining training sample data corresponding to a tunnel section. In the method 400, traveling information of a sample vehicle that is captured by a GNSS sensor may be periodically set to be ineffective and effective according to time to generate training sample data corresponding to a tunnel section.

It is to be understood that FIG. 4 shows steps or operations of the method for obtaining a training sample set corresponding to a tunnel section, but these steps or operations are only examples, and other operations or variants of the operations in the figure may alternatively be performed in embodiments of this disclosure. In addition, the steps in FIG. 4 may be performed in an order different from that shown in the figure, and not all of the operations in the figure need to be performed.

As shown in FIG. 4, the method 400 includes steps 401 to 409.

401: Obtain all effective files captured by the GNSS sensor.

For example, in a road test stage, traveling information of the sample vehicle that is captured by the sensor within a distance in a scenario without a tunnel may be obtained. The vehicle traveling information captured by the GNSS sensor may be stored in a form of a file.

402: Is an interval from file start time greater than 200 s?

The file start time may be time at which the sample vehicle starts to travel, to be specific, the GNSS sensor starts to capture traveling information of the vehicle. In the case of determining that the interval from the file start time is greater than 200 s, obtained training sample data for a simulated tunnel can include traveling information of the sample vehicle that is captured by the GNSS sensor within 200 s before the sample vehicle enters the tunnel.

403: Has a speed ever been greater than 20 km/h?

In the case of determining that the speed has ever been greater than 20 km/h, it can be ensured that the vehicle is in a normal traveling state, to ensure that vehicle traveling information obtained by the sensor is meaningful.

404: Set a file captured by the GNSS sensor to be ineffective.

In some embodiments, in the case of setting the file captured by the GNSS sensor to be ineffective, information in a file formed based on vehicle traveling information captured by sensors (for example, an IMU sensor, a visual sensor, and a speed sensor) other than the GNSS sensor on the sample vehicle may be further read, and location information of the sample vehicle that is captured by a positioning device may be obtained.

405: Does ineffective time exceed 300 s?

The ineffective time being 300 s is equivalent to traveling time on the simulated tunnel section being 300 s. In a case that the ineffective time exceeds 300 s, step 406 is performed next.

406: Set a file captured by the GNSS sensor to be effective.

It is to be understood that setting the file captured by the GNSS sensor to be effective in a case that the ineffective time exceeds 300 s is equivalent to simulating a scenario in which the vehicle travels in a normal road section after leaving the tunnel section.

407: Read file information.

Corresponding to the scenario in which the sample vehicle travels in the normal road section, information in a file formed based on traveling information of the sample vehicle that is captured by the GNSS sensor and other sensors on the vehicle and location information of the sample vehicle that is captured by the positioning device may be read.

408. Is the end of the file reached?

In a case that the end of the file is reached, the process ends. In a case that the end of the file is not reached, step 409 is performed next.

409: Does effective time exceed 200 s?

In a case that the effective time exceeds 200 s, step 404 is performed next, to continue to set the file captured by the GNSS sensor to be ineffective. In this way, the file of the GNSS sensor by be periodically (namely, alternately) set to be ineffective for 300 s and effective for 200 s, to generate each piece of data for the sample vehicle in the tunnel section based on data of the sample vehicle that is captured in the normal section.

Usually, after an autonomous vehicle enters a tunnel section, a driver may take over the autonomous vehicle. Therefore, in the tunnel section, traveling information of the vehicle that is captured by a sensor within a period of time (for example, 200 s) or a distance before the vehicle enters a tunnel is most concerned. Based on this, the file of the GNSS sensor may be periodically set to be ineffective for 300 s and effective for 200 s to generate each piece of data for the sample vehicle in the tunnel section.

It is to be understood that the time of 200 s and 300 s and the speed of 20 km/h are specific examples for case of understanding solutions in embodiments of this disclosure, and the time or speed values may alternatively be replaced with other values. Embodiments of this disclosure are not limited thereto.

Therefore, in embodiments of this disclosure, the file captured by the GNSS sensor can be periodically set to be ineffective and effective according to time, to simulate a tunnel section and generate data corresponding to the tunnel section for the sample vehicle. To be specific, a road section corresponding to an ineffective part in the file captured by the GNSS sensor may be considered as a tunnel section. In this way, a training sample set corresponding to the tunnel section is obtained, and sufficiently high precision of location information, in the training sample set, captured by the positioning device can be ensured.

250: Train a precision estimation model based on the training sample set.

For example, the modeling unit 305 in FIG. 3 may train the precision estimation model 307 based on the training sample set. For example, the modeling unit 305 may input a training sample to the precision estimation model 307 to update a parameter of the precision estimation model 307.

In some embodiments, different precision estimation models may be trained for different scenarios, to achieve optimal precision error estimation effect in the scenarios. For example, the following three scenarios may be included:
scenario 1: a non-tunnel scenario+a map scenario;
scenario 2: a tunnel scenario+a map scenario; and
scenario 3: a non-tunnel scenario+a mapless scenario.

For example, the map may be a high-definition map. This is not limited in this disclosure.

In the scenario 1, the GNSS sensor is effective, and vehicle traveling information captured by the sensor may be combined with map information for real-time positioning.

In the scenario 1, the precision estimation model may be a first precision estimation model. Third location information and a second intermediate variable in a training sample corresponding to the first precision estimation model are determined based on the second traveling information and the map information (for example, the high-definition map). The second traveling information includes traveling information of the sample vehicle that is captured by the GNSS sensor. The second intermediate variable includes information about an error between lane information determined based on the second traveling information and lane information of the sample vehicle in the map information.

In a specific example, in the training sample for the first precision estimation model, the second intermediate variable may include four categories of intermediate variables in step 220: (1) an intermediate variable obtained based on the high-definition map and information captured by the visual sensor; (2) an intermediate variable obtained based on the high-definition map and information captured by the GNSS sensor and the visual sensor; (3) a covariance of an optimization algorithm; and (4) a statistical value of a parameter captured by a statistics sensor within a period of time.

In the scenario 2, the GNSS sensor fails, and vehicle traveling information captured by sensors other than the GNSS sensor may be combined with map information for real-time positioning.

In the scenario 2, the precision estimation model may be a second precision estimation model. Third location information and a second intermediate variable in a training sample corresponding to the second precision estimation model are determined based on an effective part of the second traveling information and the map information (for example, the high-definition map). A part of traveling information, captured by the GNSS sensor, of the sample vehicle in the second traveling information is set to be ineffective. The second intermediate variable includes information about an error between lane information determined based on the second traveling information and lane information of the sample vehicle in the map information.

In some embodiments, the traveling information, captured by the GNSS sensor, of the sample vehicle in the second traveling information is periodically set to be ineffective and effective according to time.

Specifically, for a manner of setting the traveling information of the sample vehicle that is captured by the GNSS sensor to be ineffective, refer to the descriptions in step 240. Details are not described herein again.

In a specific example, in the training sample for the second precision estimation model, the second intermediate variable may include three categories of intermediate variables in step 220: (1) an intermediate variable obtained based on the high-definition map and information captured by the visual sensor; (3) a covariance of an optimization algorithm; and (4) a statistical value of a parameter captured by a statistics sensor within a period of time (not including a parameter captured by the GNSS sensor). For example, the statistical value in (4) may be a mean and a variance of a vehicle speed within 1 s, or a mean and a variance of acceleration values in the x-axis, y-axis, and z-axis directions of the accelerometer and a mean and a variance of angular velocity values in the x-axis, y-axis, and z-axis directions of the gyroscope within 10 s.

In the scenario 3, the GNSS sensor is effective, but no map information is available. Therefore, vehicle traveling information captured by the sensor cannot be combined with map information for real-time positioning.

In the scenario 3, the precision estimation model may be a third precision estimation model. Third location information and a second intermediate variable in a training sample corresponding to the third precision estimation model are determined based on the second traveling information. The second traveling information includes traveling information of the sample vehicle that is captured by the GNSS sensor.

In a specific example, in the training sample for the third precision estimation model, the second intermediate variable may include two categories of intermediate variables in step 220: (3) a covariance of an optimization algorithm; and (4) a statistical value of a parameter captured by a sensor within a period of time.

After the training sample sets are prepared for the foregoing scenarios, modeling may be performed for the foregoing scenarios. To be specific, a precision estimation model for each scenario is trained based on a training sample set corresponding to the scenario. The precision estimation model may be a machine learning model, for example, a random forest model, an xgboost model, or a deep neural network model. This is not limited.

An example of a set of algorithm configurations in a case that the precision estimation model is the xgboost model is shown below:
Number of samples: 300,000
‘booster’: ‘gbtree’
‘objective’: ‘reg:gamma’ or ‘reg:squarederror’
‘gamma’: 0.1,
‘max_depth’: 6,
‘lambda’: 3,
‘subsample’: 0.7,
‘colsample_bytree’: 0.7,
‘min_child_weight’: 3,
‘silent’: 1,
‘eta’: 0.1

For example, third location information, fourth location information, and a second intermediate variable in a training sample for each scenario may be input to a precision estimation model corresponding to the scenario. The precision estimation model may obtain fifth location information of the sample vehicle and a precision error of the third location information based on the third location information and the second intermediate variable. The precision error may be an error of the third location information relative to the fifth location information. This is not limited in this disclosure.

In some embodiments, a first loss of a model may be determined based on the fifth location information and the fourth location information during model training. In some embodiments, a second loss of a model may be determined based on a precision error of the third location information relative to the fifth location information and a precision error of the third location information relative to the fourth location information during model training. Then a parameter of the precision estimation model may be updated based on at least one of the first loss and the second loss.

In some embodiments, the precision error includes at least one of a horizontal distance error, a vertical distance error, and a heading error.

The error of the third location information relative to the fourth location information is used as an example. A component, in a direction perpendicular to a road, that is obtained by decomposing a distance between the third location information and the fourth location information is referred to as the horizontal distance error, and a component, in a direction of the road, that is obtained by decomposing the distance is referred to as the vertical distance error. In an example, a direction of the positioning device (for example, a true-value capture device) may be used as the direction of the road. The direction of the road may also be referred to as a traveling direction. This is not limited.

In a case that the fourth location information includes a longitude “lon0”, a latitude “lat0”, and a vehicle heading “heading0” and the third location information includes a longitude “lon”, a latitude “lat”, and a vehicle heading “heading”, it may be determined that the precision error of the third location information relative to the fourth location information includes a horizontal distance error “disthorizontal”, a vertical distance error “distvertical”, and a heading error.

The heading error may be a difference between the vehicle heading “heading0” and the vehicle heading “heading”, to be specific, “heading0”−“heading”.

Calculation processes for the horizontal distance error “disthorizontal” and the vertical distance error “distvertical” are as follows:

First, a distance “dist” between two locations corresponding to the fourth location information and the third location information is calculated. Specifically, the distance may be obtained based on Haversine formulas:

$$\begin{matrix}dlon = radians ( lon ) - radians ( lon 0 ) & ( 1 ) \\ dlat = radians ( lat ) - radians ( lat 0 ) & ( 2 ) \\ dist = 1000 \cdot r \cdot 2 \cdot asin ( \sqrt{{sin ( \frac{dlat}{2} )}^{2} + cos ( lat ) \cdot cos ( lat 0 ) \cdot {sin ( \frac{dlon}{2} )}^{2}} ) & ( 3 )\end{matrix}$$

radians( ) converts a longitude or a latitude into a radian. r is a mean radius of the Earth, and r=6371.393. asin( ) is an arcsine operation. sin( ) Is a sine operation. cos( ) is a cosine operation.

Then a heading “point_degree” of the two locations corresponding to the fourth location information and the third location information may be calculated. The heading “point_degree” is an angle of a direction formed by the two locations corresponding to the fourth location information and the third location information relative to the positioning device, and a value ranges from 0° to 360°. A calculation process for the heading “point_degree” is as follows:

$$\begin{matrix}dlon = radians ( lon 0 ) - radians ( lon ) & ( 4 ) \\ y = sin ( dlon ) \cdot cos ( lat 0 ) & ( 5 ) \\ x = os ( lat ) \cdot sin ( lat 0 ) - sin ( lat ) \cdot cos ( lat 0 ) \cdot cos ( dlon ) & ( 6 ) \\ point\_degree = ( atan 2 ( y , x ) + 360 ) \%360 & ( 7 )\end{matrix}$$

x represents a component of the distance between the two locations corresponding to the fourth location information and the third location information in a direction perpendicular to the positioning device, and y represents a component of the distance in a direction of the positioning device. atan2(y,x) is an arccosine operation, and may return a corresponding angle based on a positive/negative sign of x and y. % represents a modulo operation. dlon in the formulas (5) and (6) may be obtained based on the formula (4).

Finally, the horizontal distance error “disthorizontal” and the vertical distance error “distvertical” may be calculated based on the heading “point_degree”. A specific calculation process may be as follows:

$$θ = \vert heading 0 - point\_degree \vert \qquad ( 8 )$$

$$in the case of θ \leq 90 :$$

$$\begin{matrix}distvertical = dist \cdot cos ( \frac{θ}{180} \cdot π ) & ( 9 ) \\ disthorizontal = dist \cdot sin ( \frac{θ}{180} \cdot π ) & ( 10 )\end{matrix}$$

$$in the case of 90 < θ \leq 180 :$$

$$\begin{matrix}distvertical = dist \cdot sin ( \frac{θ - 90}{180} \cdot π ) & ( 11 ) \\ disthorizontal = dist \cdot cos ( \frac{θ - 90}{180} \cdot π ) & ( 12 )\end{matrix}$$

$$in the case of 180 < θ \leq 270 :$$

$$\begin{matrix}distvertical = dist \cdot cos ( \frac{θ - 180}{180} \cdot π ) & ( 13 ) \\ disthorizontal = dist \cdot sin ( \frac{θ - 180}{180} \cdot π ) & ( 14 )\end{matrix}$$

$$in the case of θ > 270 :$$

$$\begin{matrix}distvertical = dist \cdot cos ( \frac{360 - θ}{180} \cdot π ) & ( 15 ) \\ disthorizontal = dist \cdot sin ( \frac{360 - θ}{180} \cdot π ) & ( 16 )\end{matrix}$$

For the error of the third location information relative to the fifth location information, refer to the calculation process of the formulas (1) to (14). Details are not described again.

In addition, another type of scenario further exists: a tunnel scenario+a mapless scenario. In this scenario, even a high-precision sensor, for example, the IMU sensor, cannot ensure sufficiently high precision of a positioning result. Therefore, in this scenario, positioning may be set to be unavailable, and positioning precision does not need to be estimated.

Therefore, in embodiments of this disclosure, the third location information of the sample vehicle, the second intermediate variable used in the process of determining the third location information, and the fourth location information of the sample vehicle that is captured by the positioning device are determined based on the traveling information of the sample vehicle that is captured by the sensor, to train the precision estimation model and obtain a trained precision estimation model. In embodiments of this disclosure, the precision estimation model integrates location information of a vehicle that is determined based on vehicle traveling information captured by a sensor and an intermediate variable used in a process of determining the location information, to estimate a precision error of the location information.

After the precision estimation model is obtained through training, the online estimation stage may be performed. The online estimation stage is described below.

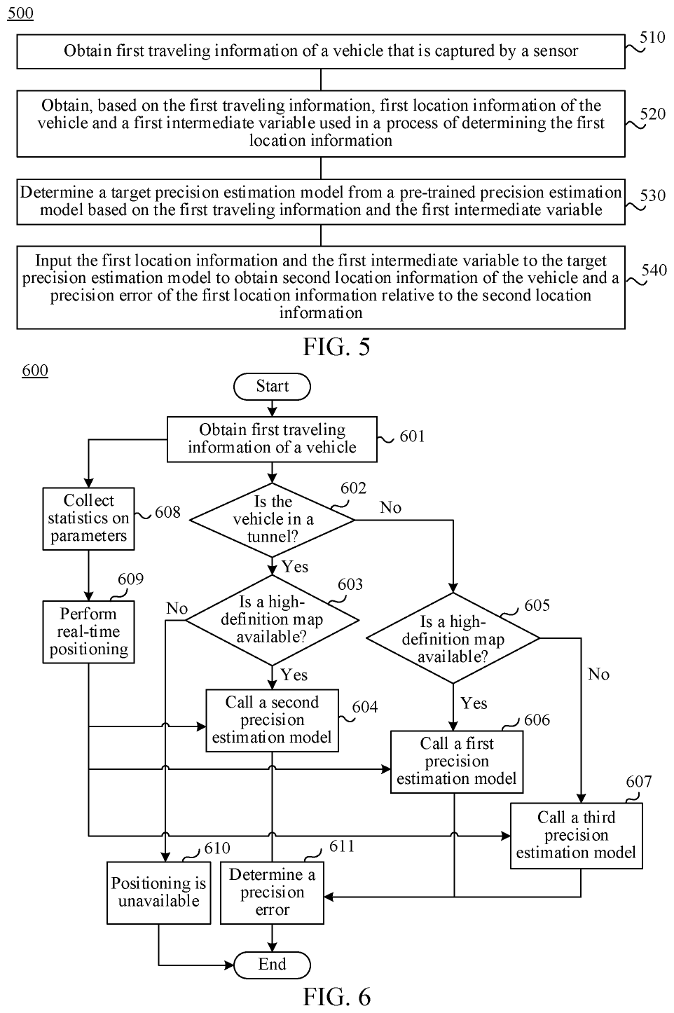

FIG. 5 is a schematic flowchart of a positioning precision estimation method 500 according to an embodiment of this disclosure. The method 500 may be performed by any electronic device with a data processing capability. For example, the electronic device may be implemented as a server or a terminal device. For another example, the electronic device may be implemented as the calculation module 109 shown in FIG. 1. This is not limited in this disclosure.

In some embodiments, the electronic device may include a machine learning model (for example, the machine learning model is deployed on the electronic device). The machine learning model may be the precision estimation model in the foregoing descriptions. Still as shown in FIG. 3, the vehicle information capture module 301, the real-time positioning module 302, the information statistics module 303, the information determining module 306, the precision estimation model 307, and the precision estimation module 308 may be used for estimating positioning precision for a vehicle. The positioning precision estimation method 500 is described with reference to FIG. 3.

As shown in FIG. 5, the method 500 includes steps 510 to 540.

510: Obtain first traveling information of a vehicle that is captured by a sensor.

For example, the vehicle information capture module 301 in FIG. 3 may obtain the first traveling information of the vehicle that is captured by the sensor. The sensor may capture first traveling information of the vehicle in a current or previous period of time. This is not limited. After obtaining the first traveling information, the vehicle information capture module 301 may transmit the first traveling information to the real-time positioning module 302 and the information determining module 306. In some embodiments, the first traveling information may be further transmitted to the information statistics module 303.

In some embodiments, the second traveling information includes traveling information of the vehicle that is captured by at least one of an inertial measurement unit (IMU) sensor, a vehicle speed sensor, and a visual sensor.

Specifically, the first traveling information captured by the sensor is similar to the second traveling information captured by the sensor in step 210 in FIG. 2. Refer to the foregoing descriptions. Details are not described herein again.

520: Obtain, based on the first traveling information, first location information of the vehicle and a first intermediate variable used in a process of determining the first location information.

For example, the real-time positioning module 302 in FIG. 3 may obtain, based on the first traveling information, the first location information of the vehicle and the first intermediate variable used in the process of determining the first location information. After obtaining the first location information and the first intermediate variable, the real-time positioning module 302 may transmit the first location information and the first intermediate variable to the precision estimation model 307.

In some embodiments, the first location information includes a longitude, a latitude, and a vehicle heading of the vehicle.

In some embodiments, the first location information and the first intermediate variable may be obtained based on the first traveling information and map information. The first intermediate variable includes information about an error between lane information determined based on the first traveling information and lane information of the vehicle in the map information.

In some embodiments, the first intermediate variable may include at least one of a covariance of an optimization algorithm used for determining the first location information and a statistical value of the first traveling information in a first time period.

For example, the information statistics module 303 in FIG. 3 may collect statistics on statistical values of parameters that are provided by the vehicle information capture module 301 within a period of time to obtain a statistical value for the first traveling information in the first time period. After obtaining the statistical value, the information statistics module 303 may transmit the statistical value to the real-time positioning module 302, or transmit the statistical value to the precision estimation model 307.

Specifically, the first location information is similar to the third location information in step 220 in FIG. 2, and the first intermediate variable is similar to the second intermediate variable in step 220 in FIG. 2. Refer to the foregoing descriptions. Details are not described herein again.

530: Determine a target precision estimation model from a pre-trained precision estimation model based on the first traveling information and the first intermediate variable. The precision estimation model is obtained by training a machine learning model based on a training sample set. A training sample in the training sample set includes location information of a sample vehicle and an intermediate variable used in a process of determining the location information.

Specifically, the training sample set may include third location information and fourth location information of the sample vehicle and a second intermediate variable used in a process of determining the third location information. The third location information is determined based on second traveling information of the sample vehicle that is captured by a sensor in first time. The fourth location information includes location information of the sample vehicle that is captured by a positioning device in the first time.

Specifically, for a training process for the precision estimation model, refer to the descriptions of FIG. 2. Details are not described herein again.

In some embodiments, the pre-trained precision estimation model includes a plurality of models respectively trained for different scenarios. In this case, the target precision estimation model may be determined from the pre-trained precision estimation model based on the first traveling information of the vehicle that is captured by the sensor and the first intermediate variable used in the process of determining the first location information. To be specific, an applicable target precision estimation model to be called may be determined based on a specific application scenario.

For example, the information determining module 306 in FIG. 3 may determine the applicable precision estimation model to be called based on the first traveling information and the first intermediate variable, to be specific, by combining the first traveling information and whether map information, for example, a high-definition map, is currently available.

In an example, in a case that the first traveling information includes traveling information of the vehicle that is captured by a GNSS sensor and map information (for example, a high-definition map) is currently available, a first precision estimation model may be further determined as the target precision estimation model. To be specific, the first precision estimation model in the foregoing scenario 1 is determined.

In another example, in a case that the first traveling information does not include traveling information of the vehicle that is captured by the GNSS sensor and map information (for example, a high-definition map) is currently available, a second precision estimation model may be further determined as the target precision estimation model. To be specific, the second precision estimation model in the foregoing scenario 2 is determined.

In another example, in a case that the first traveling information includes traveling information of the vehicle that is captured by the GNSS sensor and no map information (for example, a high-definition map) is currently available, a third precision estimation model may be further determined as the target precision estimation model. To be specific, the third precision estimation model in the foregoing scenario 3 is determined.

Specifically, for the first precision estimation model, the second precision estimation model, and the third precision estimation model, refer to the descriptions of step 250 in FIG. 2. Details are not described herein again.

540: Input the first location information and the first intermediate variable to the target precision estimation model to obtain second location information of the vehicle and a precision error of the first location information relative to the second location information.

For example, still as shown in FIG. 3, after the information determining module 306 determines an applicable target precision estimation model to be called by combining the first traveling information of the vehicle that is obtained by the sensor in the vehicle information capture module 301 and whether map information, for example, a high-definition map, is currently available, the real-time positioning module 302 and the information statistics module 303 may transmit, to the target precision estimation model, a related feature that needs to be input to the target precision estimation model.

For example, in the case of calling the first precision estimation model, the first intermediate variable may include the following intermediate variables used in the process of determining the first location information: (1) an intermediate variable obtained based on the high-definition map and information captured by the visual sensor; (2) an intermediate variable obtained based on the high-definition map and information captured by the GNSS sensor and the visual sensor; (3) a covariance of an optimization algorithm; and (4) a statistical value of a parameter captured by a statistics sensor within a period of time.

For another example, in the case of calling the second precision estimation model, the first intermediate variable may include the following intermediate variables used in the process of determining the first location information: (1) an intermediate variable obtained based on the high-definition map and information captured by the visual sensor; (3) a covariance of an optimization algorithm; and (4) a statistical value of a parameter captured by a statistics sensor within a period of time (not including a parameter captured by the GNSS sensor).

For another example, in the case of calling the third precision estimation model, the first intermediate variable may include the following intermediate variables used in the process of determining the first location information: (3) a covariance of an optimization algorithm; and (4) a statistical value of a parameter captured by a sensor within a period of time.

After a related feature is input to the first precision estimation model, the second precision estimation model, or the third precision estimation model, the model may output predicted second location information of the vehicle and a precision error of the first location information relative to the second location information.

The second location information may be location information of the vehicle that is to be captured by the positioning device as predicted by the precision estimation model, or real location information of the vehicle that is predicted by the precision estimation model. This is not limited. For example, the second location information includes a longitude, a latitude, and a vehicle heading of the vehicle.

For example, based on positioning location information of the vehicle that is determined based on the traveling information of the vehicle captured by the sensor and an intermediate variable used in a process of determining the positioning location information, the target precision estimation model can predict real location information of the vehicle that is captured by the positioning device, and estimate a precision error of the positioning location information relative to the real location information.

Therefore, in embodiments of this disclosure, the first location information of the vehicle and the first intermediate variable used in the process of determining the first location information can be obtained based on the first traveling information, and then the target precision estimation model is determined from the pre-trained precision estimation model based on the first traveling information and the first intermediate variable, and the first location information and the first intermediate variable are input to the target precision estimation model to obtain the second location information of the vehicle and the precision error of the first location information relative to the second location information. In this way, a precision error of high-precision positioning can be effectively assessed.

Compared with conventional covariance optimization, both cep90 and a mean of precision errors are greatly improved in the positioning precision estimation method in embodiments of this disclosure. The cep90 is value at a 90% place among all precision errors sorted in ascending order. For example, comparison is performed based on data sets generated for different road sections within approximately 2 to 3 hours per day within 20 days. A mean of precision errors determined in embodiments of this disclosure is improved by approximately 0.5 m on average compared with the covariance-based method.

FIG. 6 shows a specific example of a positioning precision estimation method 600 according to an embodiment of this disclosure. The method 600 may be performed by any electronic device with a data processing capability. For example, the electronic device may be implemented as a server or a terminal device. For another example, the electronic device may be implemented as the calculation module 109 shown in FIG. 1. This is not limited in this disclosure.

It is to be understood that FIG. 6 shows steps or operations of the positioning precision estimation method, but these steps or operations are only examples, and other operations or variants of the operations in the figure may alternatively be performed in embodiments of this disclosure. In addition, the steps in FIG. 6 may be performed in an order different from that shown in the figure, and not all of the operations in FIG. 6 need to be performed.

As shown in FIG. 6, the method 600 includes steps 601 to 610.

601: Obtain first traveling information of a vehicle.

Specifically, for step 601, refer to the descriptions in step 510. Details are not described herein again.

602: Is the vehicle in a tunnel?

Specifically, whether the vehicle is located in a tunnel section may be determined based on the first traveling information in 601. For example, in a case that the first traveling information includes traveling information of the vehicle that is captured by a GNSS sensor, it may be determined that the vehicle is not located in a tunnel section; or in a case that the first traveling information does not include traveling information of the vehicle that is captured by the GNSS sensor, it may be determined that the vehicle is located in a tunnel section.

In a case that the vehicle is located in a tunnel section, step 603 is performed next. In a case that the vehicle is not located in a tunnel section, step 605 is performed next.

603: Is a high-definition map available?

To be specific, in a tunnel scenario, whether a high-definition map is available is further determined. In a case that a high-definition map is available, step 604 is performed next. In a case that no high-definition map is available, step 610 is performed next.

604: Call a second precision estimation model.

605: Is a high-definition map available?

To be specific, in a non-tunnel scenario, whether a high-definition map is available is further determined. In a case that a high-definition map is available, step 606 is performed next. In a case that no high-definition map is available, step 607 is performed next.

606: Call a first precision estimation model.

607: Call a third precision estimation model.

Specifically, for the first precision estimation model, the second precision estimation model, and the third precision estimation model, refer to the descriptions of FIG. 2 and FIG. 5. Details are not described herein again.

608: Collect statistics on parameters.

Specifically, statistics may be collected on traveling parameters in the first traveling information in step 601 to obtain statistical values of the traveling parameters. 609: Perform real-time positioning.

Specifically, first location information of the vehicle may be determined based on the first traveling information in step 601 and the statistical values obtained in step 608. A real-time positioning result (namely, the first location information) and an intermediate variable used in a process of determining the first location information may be input to a corresponding precision estimation model. Specifically, for parameters that are input to different precision estimation models, refer to the descriptions of FIG. 5. Details are not described herein again.

610: Positioning is unavailable.

To be specific, in a case that no high-definition map is available in the tunnel scenario, it is determined that positioning is unavailable.

611: Determine a precision error.

Specifically, precision errors of real-time positioning results in different scenarios may be determined based on results of calling precision estimation models in different scenarios.

Therefore, in embodiments of this disclosure, the first location information of the vehicle and the first intermediate variable used in the process of determining the first location information can be obtained based on the first traveling information, and then the target precision estimation model is determined from the pre-trained precision estimation model based on the first traveling information and the first intermediate variable, and the first location information and the first intermediate variable are input to the target precision estimation model to obtain the second location information of the vehicle and the precision error of the first location information relative to the second location information. In this way, a precision error of high-precision positioning can be effectively assessed.

Specific implementations of this disclosure are described in detail above with reference to the accompanying drawings. However, this disclosure is not limited to specific details in the foregoing implementations, a plurality of simple variations may be made to the technical solutions of this disclosure within a scope of the technical concept of this disclosure, and these simple variations fall within the protection scope of this disclosure. For example, the specific technical features described in the foregoing specific implementations may be combined in any proper manner in a case without conflict. To avoid unnecessary repetition, various possible combinations are not additionally described in this disclosure. For another example, different implementations of this disclosure may also be arbitrarily combined without departing from the idea of this disclosure, and these combinations shall still be regarded as content disclosed in this disclosure.

It is to be understood that, in various method embodiments of this disclosure, an order of sequence numbers of the foregoing processes does not indicate an execution sequence, and an execution sequence of the processes is to be determined based on functions and internal logic thereof and does not constitute any limitation on an implementation process of embodiments of this disclosure. It is to be understood that these sequence numbers are interchangeable where appropriate so that the described embodiments of this disclosure can be implemented in an order other than those illustrated or described.

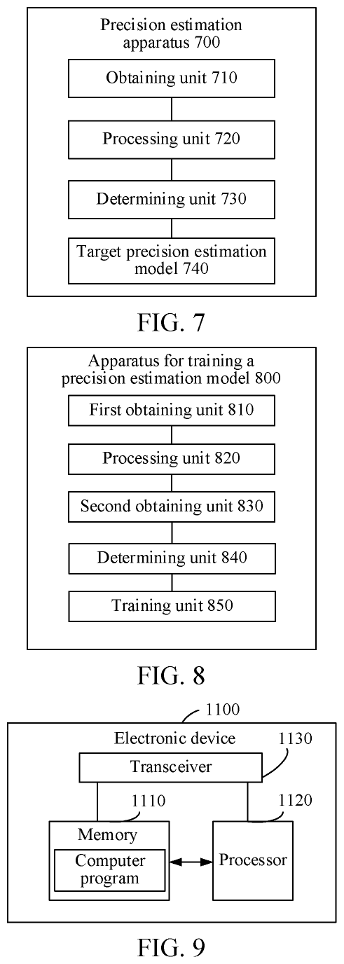

The foregoing describes method embodiments of this disclosure in detail. The following describes apparatus embodiments of this disclosure in detail with reference to FIG. 7 to FIG. 9.

FIG. 7 is a schematic block diagram of a positioning precision estimation apparatus 700 according to an embodiment of this disclosure. As shown in FIG. 7, the positioning precision estimation apparatus 700 may include an obtaining unit 710, a processing unit 720, and a determining unit 730.

The obtaining unit 710 is configured to obtain first traveling information of a vehicle that is captured by a sensor.

The processing unit 720 is configured to obtain, based on the first traveling information, first location information of the vehicle and a first intermediate variable used in a process of determining the first location information.

The determining unit 730 is configured to determine a target precision estimation model from a pre-trained precision estimation model based on the first traveling information and the first intermediate variable. The precision estimation model is obtained by training a machine learning model based on a training sample set. A training sample in the training sample set includes location information of a sample vehicle and an intermediate variable used in a process of determining the location information.

The target precision estimation model 740 is used for inputting the first location information and the first intermediate variable to obtain second location information of the vehicle and a precision error of the first location information relative to the second location information.

In some embodiments, the processing unit 720 is specifically configured to:
obtain the first location information and the first intermediate variable based on the first traveling information and map information, the first intermediate variable including information about an error between lane information determined based on the first traveling information and lane information of the vehicle in the map information.

In some embodiments, the first traveling information includes traveling information of the vehicle that is captured by a global navigation satellite system (GNSS) sensor; and
the determining unit 730 is specifically configured to:
determine a first precision estimation model as the target precision estimation model based on the first traveling information and the first intermediate variable, location information and an intermediate variable in a training sample set for the first precision estimation model being determined based on traveling information of the sample vehicle that is captured by the GNSS sensor and the map information.

In some embodiments, the determining unit 730 is specifically configured to:
determine a second precision estimation model as the target precision estimation model based on the first traveling information and the first intermediate variable, location information and an intermediate variable in a training sample set corresponding to the second precision estimation model being determined based on an effective part of traveling information of the sample vehicle that is captured by a GNSS sensor and the map information, and a part of the traveling information of the sample vehicle that is captured by the GNSS sensor being set to be ineffective.

In some embodiments, the traveling information of the sample vehicle that is captured by the GNSS sensor is periodically set to be ineffective and effective according to time.

In some embodiments, the first traveling information includes traveling information of the vehicle that is captured by a GNSS sensor; and
the determining unit 730 is specifically configured to:
determine a third precision estimation model as the precision estimation model based on the first traveling information and the first intermediate variable, location information and an intermediate variable in a training sample set corresponding to the third precision estimation model being determined based on traveling information of the sample vehicle that is captured by the GNSS sensor.

In some embodiments, the second traveling information includes traveling information of the vehicle that is captured by at least one of an inertial measurement unit (IMU) sensor, a vehicle speed sensor, and a visual sensor.

In some embodiments, the first intermediate variable includes at least one of a covariance of an optimization algorithm used for determining the first location information and a statistical value of the first traveling information in a first time period.

In some embodiments, the first location information includes a first longitude, a first latitude, and a first vehicle heading of the vehicle, and the second location information includes a second longitude, a second latitude, and second vehicle heading of the vehicle.

In some embodiments, the precision error includes at least one of a horizontal distance error, a vertical distance error, and a heading error.

It is to be understood that the apparatus embodiments may correspond to the method embodiments. For similar descriptions, refer to the method embodiments. To avoid repetition, details are not described herein again. Specifically, the positioning precision estimation apparatus 700 in this embodiment may correspond to a corresponding entity for performing the method 500 or 600 in embodiments of this disclosure, and the foregoing and other operations and/or functions of the modules in the apparatus 700 are respectively intended to implement the corresponding processes in the method 500 or 600. For brevity, details are not described herein again.

FIG. 8 is a schematic block diagram of an apparatus 800 for training a precision estimation model according to an embodiment of this disclosure. As shown in FIG. 8, the apparatus 800 for training a precision estimation model may include a first obtaining unit 810, a processing unit 820, a second obtaining unit 830, a determining unit 840, and a training unit 850.

The first obtaining unit 810 is configured to obtain second traveling information of a sample vehicle that is captured by a sensor in first time.

The processing unit 820 is configured to obtain, based on the second traveling information, third location information of the sample vehicle and a second intermediate variable used in a process of determining the third location information.

The second obtaining unit 830 is configured to obtain fourth location information of the sample vehicle that is captured by a positioning device in the first time.

The determining unit 840 is configured to determine a training sample set, the training sample set including the third location information, the fourth location information, and the second intermediate variable.

The training unit 850 is configured to train the precision estimation model based on the training sample set.

In some embodiments, the precision estimation model includes a first precision estimation model, and the second traveling information includes traveling information of the sample vehicle that is captured by a global navigation satellite system (GNSS) sensor;
the processing unit 820 is specifically configured to:
obtain the third location information and the second intermediate variable based on the second traveling information and map information, the second intermediate variable including information about an error between lane information determined based on the second traveling information and lane information of the sample vehicle in the map information; and
the training unit 850 is specifically configured to train the first precision estimation model based on the training sample set.

In some embodiments, the precision estimation model includes a second precision estimation model, and the second traveling information includes traveling information of the sample vehicle that is captured by a global navigation satellite system (GNSS) sensor;
the processing unit 820 is further configured to: set a part of the traveling information of the sample vehicle that is captured by the GNSS sensor to be ineffective; and
obtain the third location information and the second intermediate variable based on an effective part of the second traveling information and map information, the second intermediate variable including information about an error between lane information determined based on the second traveling information and lane information of the sample vehicle in the map information; and
the training unit is specifically configured to train the second precision estimation model based on the training sample set.

In some embodiments, the precision estimation model includes a third precision estimation model, and the second traveling information includes traveling information of the sample vehicle that is captured by a global navigation satellite system (GNSS) sensor; and the training unit 850 is specifically configured to:
train the third precision estimation model based on the training sample set.

In some embodiments, the second traveling information includes traveling information of the sample vehicle that is captured by at least one of an inertial measurement unit (IMU) sensor, a vehicle speed sensor, and a visual sensor.

In some embodiments, the second intermediate variable includes at least one of a covariance of an optimization algorithm used for determining the third location information and a statistical value of the second traveling information in a second time period.

It is to be understood that the apparatus embodiments may correspond to the method embodiments. For similar descriptions, refer to the method embodiments. To avoid repetition, details are not described herein again. Specifically, the model training apparatus 800 in this embodiment may correspond to a corresponding entity for performing the method 200 in embodiments of this disclosure, and the foregoing and other operations and/or functions of the modules in the apparatus 800 are respectively intended to implement the corresponding processes in the method 200. For brevity, details are not described herein again.

The foregoing describes the apparatuses and systems in embodiments of this disclosure from a perspective of functional modules with reference to the accompanying drawings. It is to be understood that the functional modules may be implemented in a form of hardware, or may be implemented by instructions in a form of software, or may be implemented by a combination of hardware and software modules. Specifically, the steps of the method embodiments in embodiments of this disclosure may be performed by an integrated logic circuit in a processor and/or instructions in a form of software, and the steps of the methods disclosed with reference to embodiments of this disclosure may be directly performed by a hardware decoding processor, or may be performed by a combination of hardware and software modules in a decoding processor. In some embodiments, the software module may be located in a mature storage medium in the art, such as a random access memory, a flash memory, a read-only memory, a programmable read-only memory or electrically erasable programmable memory, or a register. The storage medium is located in the memory. The processor reads information in the memory and completes the steps in the method embodiments in combination with hardware thereof.

FIG. 9 is a schematic block diagram of an electronic device 1100 according to an embodiment of this disclosure.

As shown in FIG. 9, the electronic device 1100 may include a memory 1110 and a processor 1120. The memory 1110 is configured to store a computer program, and transmit the program code to the processor 1120. In other words, the processor 1120 may call the computer program from the memory 1110 and run the computer program, to implement the methods in embodiments of this disclosure.

For example, the processor 1120 may be configured to perform the steps in the method 200 according to instructions in the computer program.

In some embodiments of this disclosure, the processor 1120 may include but is not limited to a general-purpose processor, a digital signal processor (DSP), an application-specific integrated circuit (ASIC), a field programmable gate array (FPGA) or another programmable logic device, a discrete gate or transistor logic device, a discrete hardware component, and the like.

In some embodiments of this disclosure, the memory 1110 includes but is not limited to a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and serves as an external cache. By way of example but not limitative description, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

In some embodiments of this disclosure, the computer program may be divided into one or more modules, and the one or more modules are stored in the memory 1110 and executed by the processor 1120 to perform the methods provided in this disclosure. The one or more modules may be a series of computer program instruction segments capable of performing specific functions, and the instruction segments are used for describing execution processes of the computer program on the electronic device 1100.

In some embodiments, as shown in FIG. 9, the electronic device 1100 may further include a transceiver 1130. The transceiver 1130 may be connected to the processor 1120 or the memory 1110. The processor 1120 may control the transceiver 1130 to communicate with another device, specifically, to transmit information or data to another device, or receive information or data transmitted by another device. The transceiver 1130 may include a transmitter and a receiver. The transceiver 1130 may further include an antenna. There may be one or more antennas.

It is to be understood that components of the electronic device 1100 are connected through a bus system. In addition to a data bus, the bus system further includes a power bus, a control bus, and a status signal bus.

According to an aspect of this disclosure, a communications apparatus is provided and includes a memory and a processor. The memory is configured to store a computer program. The processor is configured to call and run the computer program stored in the memory, so that the encoder performs the methods in the method embodiments.

According to an aspect of this disclosure, a computer storage medium is provided, having a computer program stored therein. When the computer program is executed by a computer, the computer is enabled to perform the methods in the method embodiments. Alternatively, embodiments of this disclosure further provide a computer program product including instructions, and when the instructions are executed by a computer, the computer is enabled to perform the methods in the method embodiments.

According to another aspect of this disclosure, a computer program product or a computer program is provided. The computer program product or the computer program includes computer instructions, and the computer instructions are stored in a computer-readable storage medium. A processor of a computer device reads the computer instructions from the computer-readable storage medium, and the processor executes the computer instructions, so that the computer device performs the methods in the method embodiments.

In other words, when software is used to implement the embodiments, all or some of the embodiments may be implemented in a form of a computer program product. The computer program product includes one or more computer instructions. When the computer program instructions are loaded and executed on a computer, all or some of the processes or functions according to embodiments of this disclosure are produced. The computer may be a general-purpose computer, a special-purpose computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, wireless, or microwave) manner. The computer-readable storage medium may be any usable medium accessible to a computer, or a data storage device, for example, a server or a data center, integrating one or more available media. The available medium may be a magnetic medium (for example, a floppy disk, a hard disk, or a magnetic tape), an optical medium (for example, a digital video disc (DVD)), a semiconductor medium (for example, a solid state disk (SSD)), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (c.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

It is noted that the exemplary modules and algorithm steps described with reference to the embodiments disclosed in this specification can be implemented in electronic hardware, or a combination of computer software and electronic hardware. Whether the functions are performed by hardware or software depends on particular applications and design constraints of technical solutions. It is noted that different methods can be used to implement the described functions for each particular application.

In the several embodiments provided in this disclosure, it is to be understood that the disclosed devices, apparatuses, and methods may be implemented in other manners. For example, the apparatus embodiments described above are merely exemplary. For example, the module division is merely logical function division and may be other division in actual implementation. For example, a plurality of modules or components may be combined or integrated into another system, or some features may be ignored or not performed. In addition, the shown or discussed mutual couplings or direct couplings or communication connections may be implemented through some interfaces. The indirect couplings or communication connections between the apparatuses or modules may be implemented in electronic, mechanical, or other forms.

The modules shown as separate parts may or may not be physically separate, and the parts shown as modules may or may not be physical modules, may be located in one place, or may be distributed on a plurality of network units. Some or all of the modules may be selected according to actual needs to achieve the objectives of the solutions of the embodiments. In addition, functional modules in embodiments of in this disclosure may be integrated into one processing module, or each of the modules may exist alone physically, or two or more modules may be integrated into one module.

The foregoing descriptions are merely examples of implementations of this disclosure, but are not intended to limit the protection scope of this disclosure. It is noted that other suitable variation or replacement within the technical scope disclosed in this disclosure shall fall within the protection scope of this disclosure.

What is claimed is:

1. A method for positioning precision estimation, comprising:
obtaining first traveling information of a vehicle from a sensor associated with the vehicle;
determining, based on the first traveling information, first location information of the vehicle and a first intermediate variable that is used in the determining the first location information;
determining a target precision estimation model from a plurality of pre-trained precision estimation models based on the first traveling information and the first intermediate variable, the plurality of pre-trained precision estimation models being obtained by training a machine learning model based on a training sample set, and a training sample in the training sample set comprising sample location information of a sample vehicle and a sample intermediate variable that is used in determining the sample location information of the sample vehicle; and
inputting the first location information and the first intermediate variable into the target precision estimation model to obtain second location information of the vehicle and a precision error of the first location information relative to the second location information.

2. The method according to claim 1, wherein the determining the first location information of the vehicle and the first intermediate variable comprises:
determining the first location information and the first intermediate variable based on the first traveling information and map information, the first intermediate variable comprising an error between first lane information determined based on the first traveling information and second lane information of the vehicle according to the map information.

3. The method according to claim 2, wherein the first traveling information comprises traveling information of the vehicle that is captured by a global navigation satellite system (GNSS) sensor, the determining the target precision estimation model comprises:
determining a first precision estimation model as the target precision estimation model based on the first traveling information and the first intermediate variable, a first training sample in a first training sample set for training the first precision estimation model comprising first sample location information and a first sample intermediate variable that are determined based on first sample traveling information of the sample vehicle, the first sample traveling information being captured by a sample GNSS sensor and the map information.

4. The method according to claim 2, wherein the determining the target precision estimation model comprises:
determining a second precision estimation model as the target precision estimation model based on the first traveling information and the first intermediate variable, a second training sample in a second training sample set for training the second precision estimation model comprising at least an effective part of second sample traveling information of the sample vehicle that is captured by a sample GNSS sensor and the map information, and the second sample traveling information of the sample vehicle captured by the sample GNSS sensor comprising the effective part and at least an ineffective part that is set to be ineffective to simulate a tunnel scenario.

5. The method according to claim 4, wherein the second sample traveling information of the sample vehicle that is captured by the sample GNSS sensor is periodically set to be ineffective and effective according to time.

6. The method according to claim 1, wherein the first traveling information comprises traveling information of the vehicle that is captured by a GNSS sensor,
the determining the target precision estimation model comprises:
determining a third precision estimation model as the target precision estimation model based on the first traveling information and the first intermediate variable, a third sample in a third training sample set for training the third precision estimation model being determined based on sample traveling information of the sample vehicle that is captured by a sample GNSS sensor.

7. The method according to claim 1, wherein the first traveling information comprises traveling information of the vehicle that is captured by at least one of an inertial measurement unit (IMU) sensor, a vehicle speed sensor, and a visual sensor.

8. The method according to claim 1, wherein the first intermediate variable comprises at least one of a covariance of an optimization algorithm used for determining the first location information and a statistical value of the first traveling information in a first time period.

9. The method according to claim 1, wherein the first location information comprises a first longitude, a first latitude, and a first vehicle heading of the vehicle, and the second location information comprises a second longitude, a second latitude, and second vehicle heading of the vehicle.

10. The method according to claim 1, wherein the precision error comprises at least one of a horizontal distance error, a vertical distance error, and a heading error.

11. A method for training a precision estimation model, comprising:
obtaining sample traveling information of a sample vehicle in a first time from a sensor;
determining, based on the sample traveling information, first sample location information of the sample vehicle and a sample intermediate variable that is used in the determining the first sample location information;
obtaining second sample location information of the sample vehicle in the first time from a positioning device;
determining a training sample set, a training sample in the training sample set comprising the first sample location information, the second sample location information, and the sample intermediate variable; and
training the precision estimation model based on the training sample set.

12. The method according to claim 11, wherein the precision estimation model comprises a first precision estimation model, the sample traveling information comprises traveling information of the sample vehicle that is captured by a global navigation satellite system (GNSS) sensor,
the determining the first sample location information of the sample vehicle and the sample intermediate variable comprises:
determining the first sample location information and the sample intermediate variable based on the sample traveling information and map information, the sample intermediate variable comprising an error between first lane information of the sample vehicle determined based on the sample traveling information and second lane information of the sample vehicle according to the map information.

13. The method according to claim 11, wherein the precision estimation model comprises a second precision estimation model, the sample traveling information comprises traveling information of the sample vehicle that is captured by a global navigation satellite system (GNSS) sensor, the method further comprises:
setting a part of the sample traveling information of the sample vehicle that is captured by the GNSS sensor to be ineffective for simulating a tunnel scenario.

14. The method according to claim 13, wherein the determining the first sample location information of the sample vehicle and the sample intermediate variable comprises:
obtaining the first sample location information and the sample intermediate variable based on an effective part of the sample traveling information and map information, the sample intermediate variable comprising an error between first lane information determined of the sample vehicle based on the sample traveling information and second lane information of the sample vehicle according to the map information.

15. An apparatus for positioning precision estimation, comprising processing circuitry configured to:
obtain first traveling information of a vehicle from a sensor associated with the vehicle;
determine, based on the first traveling information, first location information of the vehicle and a first intermediate variable that is used in the determining the first location information;
determine a target precision estimation model from a plurality of pre-trained precision estimation models based on the first traveling information and the first intermediate variable, the plurality of pre-trained precision estimation models being obtained by training a machine learning model based on a training sample set, a training sample in the training sample set comprising sample location information of a sample vehicle and a sample intermediate variable that is used in determining the sample location information of the sample vehicle; and
input the first location information and the first intermediate variable into the target precision estimation model to obtain second location information of the vehicle and a precision error of the first location information relative to the second location information.

16. The apparatus according to claim 15, wherein the processing circuitry is configured to:
determine the first location information and the first intermediate variable based on the first traveling information and map information, the first intermediate variable comprising an error between first lane information determined based on the first traveling information and second lane information of the vehicle according to the map information.

17. The apparatus according to claim 16, wherein the first traveling information comprises traveling information of the vehicle that is captured by a global navigation satellite system (GNSS) sensor, and the processing circuitry is configured to:
determine a first precision estimation model as the target precision estimation model based on the first traveling information and the first intermediate variable, a first training sample in a first training sample set for training the first precision estimation model comprising first sample location information and a first sample intermediate variable that are determined based on first sample traveling information of the sample vehicle, the first sample traveling information being captured by a sample GNSS sensor and the map information.

18. The apparatus according to claim 16, wherein the processing circuitry is configured to:
determine a second precision estimation model as the target precision estimation model based on the first traveling information and the first intermediate variable, a second training sample in a second training sample set for training the second precision estimation model comprising at least an effective part of second sample traveling information of the sample vehicle that is captured by a sample GNSS sensor and the map information, and the second sample traveling information of the sample vehicle captured by the sample GNSS sensor comprising the effective part and at least an ineffective part that is set to be ineffective to simulate a tunnel scenario.

19. The apparatus according to claim 18, wherein the second sample traveling information of the sample vehicle that is captured by the sample GNSS sensor is periodically set to be ineffective and effective according to time.

20. The apparatus according to claim 15, wherein the first traveling information comprises traveling information of the vehicle that is captured by a GNSS sensor, and the processing circuitry is configured to:
determine a third precision estimation model as the target precision estimation model based on the first traveling information and the first intermediate variable, a third sample in a third training sample set for training the third precision estimation model being determined based on sample traveling information of the sample vehicle that is captured by a sample GNSS sensor.
